(19) United States
(12) Patent Application Publication
(10) Pub. No.: US 2014/0314893 A1
(43) Pub. Date: Oct. 23, 2014

(54) MOLD FOR MOLDING LIGHT GUIDE PLATE

(71) Applicant: HON HAI PRECISION INDUSTRY CO., LTD., New Taipei (TW)

(72) Inventors: YUN-YU CHOU, New Taipei (TW); KO-HUA CHEN, New Taipei (TW)

(73) Assignee: HON HAI PRECISION INDUSTRY CO., LTD., New Taipei (TW)

(21) Appl. No.: 14/014,420

(22) Filed: Aug. 30, 2013

(30) Foreign Application Priority Data
Apr. 23, 2013 (TW) 102114473

(51) Int. Cl. B29C 45/26

(52) U.S. Cl. CPC B29C 45/2673
USPC 425/183

(57) ABSTRACT

A mold assembly for manufacturing light guide plates of different sizes without being dismantled includes a male mold with base, a number of pairs of molding blocks and driving blocks, together with two bolts, and an injecting block. The pairs of molding and driving blocks, and the driving block and two bolts are received in the male mold base. The driving block is movably connected to the molding block by the two bolts. A position of the molding block relative to the driving block is adjusted by screwing at least one of the two bolts. An injecting block is positioned in the male mold base and surrounds a male mold chamber with the molding block.

### BACKGROUND

1. Technical Field

The present disclosure relates to molds and, particularly, to a mold for molding a light guide plate.

2. Description of Related Art

Molds for molding light guide plates generally include a mold base, a number of molding blocks, and a number of driving blocks. The molding blocks and the driving blocks are received in the mold base. Each driving block is coupled with one of the molding blocks, and drives the molding block to move to a preset position. Thus, a molding chamber for molding the light guide plates is formed by the molding blocks. However, the mold needs to be entirely disassembled when a deviation or different setup of a molding block is required, which is complicated and inefficient.

Therefore, it is desirable to provide a mold that can overcome the limitations described.

### BRIEF DESCRIPTION OF THE DRAWINGS

FIG. 1 is a schematic view of a mold in accordance with an exemplary embodiment.

FIG. 2 is a top view of a male mold of the mold of FIG. 1.

FIG. 3 is a top view of a female mold of the mold of FIG. 1.

### DETAILED DESCRIPTION

Embodiments of the disclosure will be described with reference to the drawings.

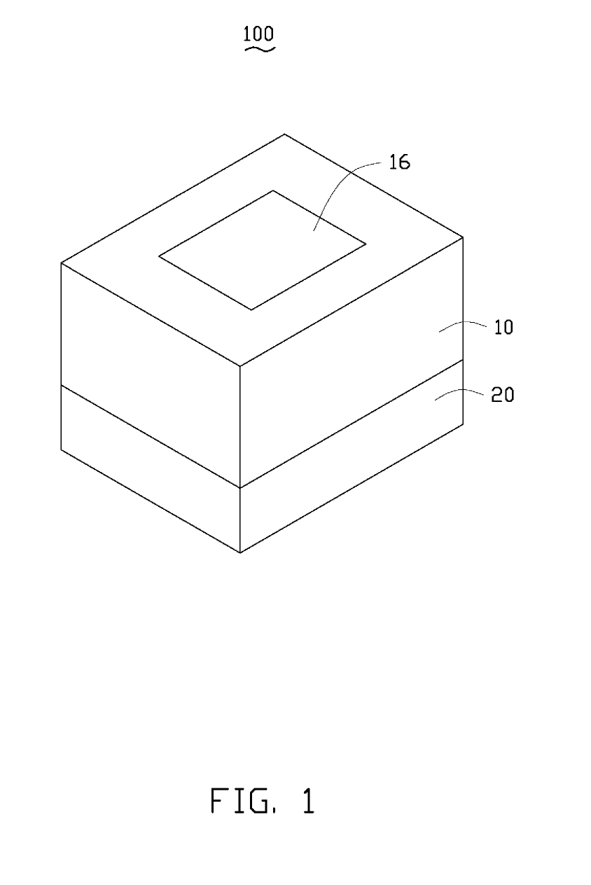

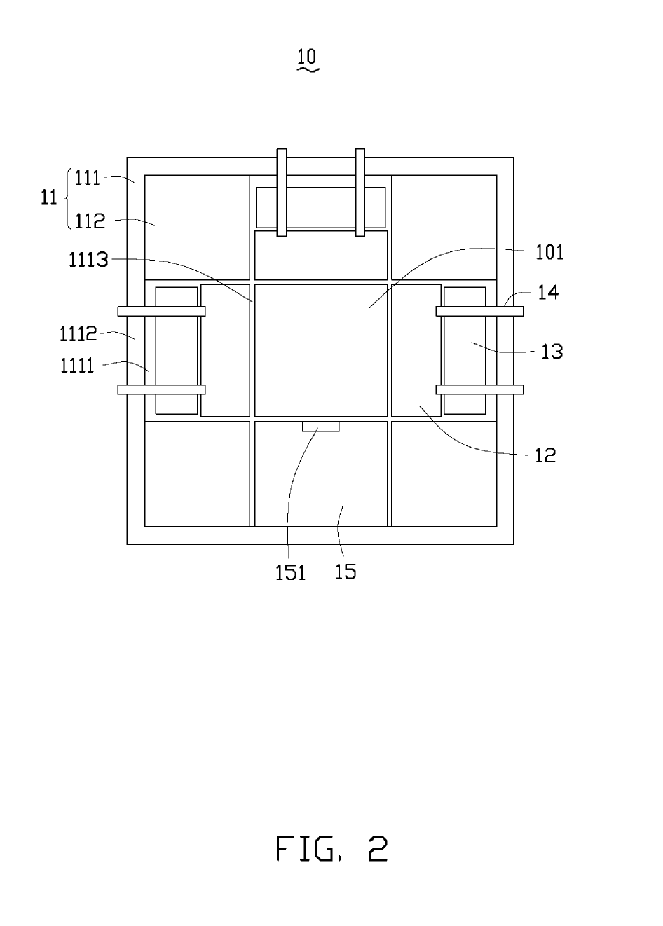

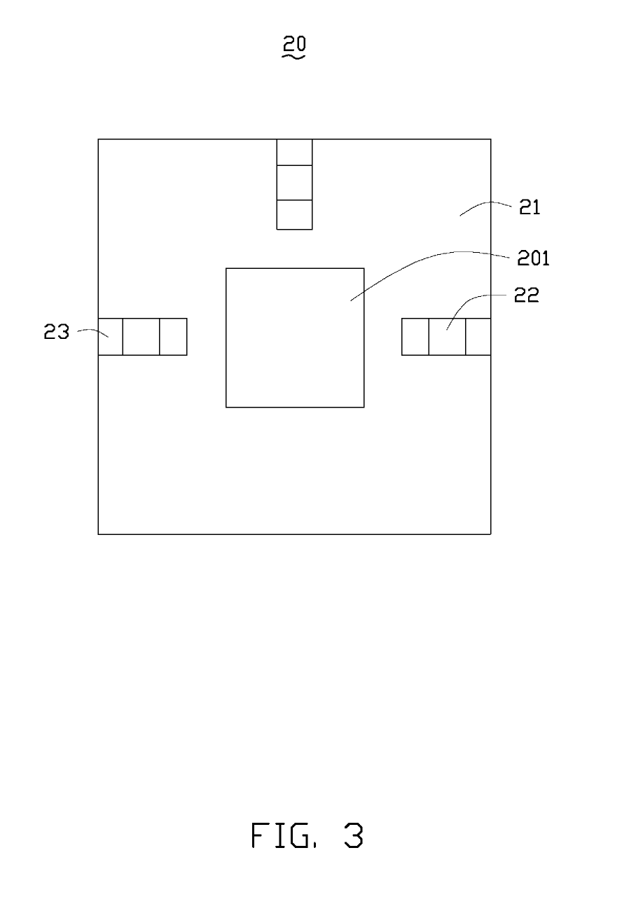

FIGS. 1-3 show a mold 100, according to an exemplary embodiment. The mold 100 is configured for molding a light guide plate (not shown). The mold 100 includes a male mold 10 and a female mold 20 to couple with the male mold 10. The mold 100 can be used to mold other articles.

The male mold 10 includes a male mold base 11, a number of molding blocks 12, a number of molding driving blocks 13, a number of bolts 14, an injecting block 15, and a pressing plate 16.

The male mold base 11 is substantially rectangular and includes a frame 111 and four position blocks 112. The frame 111 includes a bottom plate 1111 and four side plates 1112 substantially perpendicularly positioned at four edges of the bottom plate 1111. Two parallel side plates 1112 are perpendicular to two other parallel side plates 1112. Each position block 112 is positioned at a corner of two adjacent side plates 1112. The bottom plate 1111 defines a through hole 1113 at a center thereof. The shape of the light guide plate corresponds to the shape of the through hole 1113.

The molding blocks 12, the driving blocks 13, and the bolts 14 are received in the male mold base 11. Each driving block 13 is movably connected to a molding block 12 via at least two bolts 14. Each bolt 14 is screwed to the driving block 13, and one end of each bolt 14 penetrating the driving block 13 is rotatably connected to the molding block 12. A position of the molding block 12 relative to the driving block 13 can be adjusted by screwing at least one of two bolts 14. Another end of the bolt 14 facing away from the molding block 12 protrudes out of the male mold base 11. The driving block 13 takes the molding block 12 to a preset position. In the embodiment, each molding block 12 includes a bearing (not shown) sleeved on one bolt 14.

In the embodiment, the number of pairs comprising molding block 12 and driving block 13 is three. Each pair of the molding blocks 12 and the driving block 13 is adjacent to a side plate 1112, and each pair of the molding block 12 and the driving block 13 is received between two adjacent position blocks 112. A moving direction of the molding block 12 and the driving block 13 is perpendicular to the adjacent side plates 1112. A distance between two adjacent position blocks 112 is slightly greater than a width of the molding block 12 and the driving block 13 together extending along the adjacent side plates 1112, the moving direction of the molding block 12 and the driving block 13 being limited by the position blocks 112.

The injecting block 15 is positioned in the male mold base 11, and is adjacent to one side plate 1112. The injecting block 15 is opposite one pair of the molding block 12 and the driving block 13. The molding blocks 12 in their preset positions and the injecting block 15 surround a male mold chamber 101. The injecting block 15 defines an injecting hole 151 communicating with the male mold chamber 101.

The pressing plate 16 protrudes into the male mold chamber 101 through the through hole 1113. A depth of the pressing plate 16 protruding into the male mold chamber 101 governs a thickness of the light guide plate. A driver (not shown) is connected to a side of the pressing plate 16 facing away from the male mold chamber 101. The driver drives the pressing plate 16 to move linearly in the male mold chamber 101.

The female mold 20 is substantially rectangular and includes a female mold base 21 and a number of driving devices 22. The female mold 20 defines a female mold chamber 201 and a number of receiving recess 23 surrounding the female mold chamber 201. The female mold chamber 201 is defined at a center of the female mold 20, and the shape of the female mold chamber 201 corresponds to the shape of the male mold chamber 101. Each receiving recess 23 extending along a direction perpendicular to an adjacent edge of the female mold base 21. The position of the receiving recess 23 corresponds to the position of the driving block 13. The driving devices 22 are received in the receiving recesses 23. In the embodiment, the number of the driving devices 22 is three. The female mold base 21 defines three receiving recesses 23 corresponding to the number of the driving devices 22.

During the process of molding the light guide plate, the driving devices 22 are coupled to the driving blocks 13 when the female mold 20 is clamped together with the male mold 10. In the embodiment, the driving devices 22 and the driving blocks 13 define a detachable coupling structure. When the driving devices 22 are coupled to the driving blocks 13, the driving devices 22 drive the driving blocks 13 to move, thereby the molding blocks 12 are driven to their preset positions by the driving blocks 13. The male mold chamber 101 is defined by the molding blocks 12 and the injecting block 15. Then the depth of the pressing plate 16 protruding into the male mold chamber 101 is adjusted. Finally, a glue or resin is injected into the male mold chamber 101 and the female mold chamber 201 via the injecting hole 151, to form a light guide plate.

When a side of a molded light guide plate needs to be changed, it means that the positions of the molding blocks 12 need to be changed correspondingly. The position of the molding blocks 12 relative to the driving blocks 13 is adjusted by screwing at least one of the two bolts 14, and the shape of the male mold chamber 101 is thus modified.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A mold, comprising:
a male mold, comprising:
a male mold base;
a plurality of molding blocks received in the male mold base;
a plurality of driving blocks received in the male mold base;
a plurality of bolts received in the male mold base, each of the driving blocks movably connected to a respective one of the molding blocks via at least two of the bolts, a position of each molding block relative to the respective driving block being adjusted by screwing at least one bolt; and
an injecting block positioned in the male mold base, the injecting block and the molding blocks cooperatively defining and surrounding a male mold chamber; and
a female mold, comprising:
a female mold base defining a female mold chamber and a plurality of receiving recesses surrounding the female mold chamber; and
a plurality of driving devices respectively received in the receiving recesses and coupled to the driving blocks.

2. The mold of claim 1, wherein the injecting block defines an injecting hole communicating with the male mold chamber.

3. The mold of claim 1, wherein the male mold base comprises a frame, the molding blocks, the driving blocks, and the bolts are received in the frame, the frame comprises a bottom plate and four side plates positioned at four edges of the bottom plate, the bottom plate defines a through hole communicating with the male mold chamber.

4. The mold of claim 3, wherein the male mold comprises a pressing plate protruding into the male mold chamber through the through hole.

5. The mold of claim 3, wherein the male mold base comprises four position blocks positioned at corners of the frame, each molding block and the respective driving block are received between two adjacent position blocks.

6. The mold of claim 1, wherein one end of each bolt penetrates the respective driving block and is rotatably connected to the respective molding block.

7. The mold of claim 1, wherein the driving devices drives the driving blocks to move.

8. A male mold, comprising:
a male mold base;
a plurality of molding blocks received in the male mold base;
a plurality of driving blocks received in the male mold base;
a plurality of bolts received in the male mold base, each of the driving blocks movably connected to a respective one of the molding blocks via at least two of the bolts, a position of each molding block relative to the respective driving block being adjusted by screwing at least one bolt; and
an injecting block positioned in the male mold base, the injecting block and the molding blocks cooperatively defining and surrounding a male mold chamber.

9. The male mold of claim 8, wherein the injecting block defines an injecting hole communicating with the male mold chamber.

10. The male mold of claim 8, wherein the male mold base comprises a frame, the molding blocks, the driving blocks, and the bolts are received in the frame, the frame comprises a bottom plate and four side plates positioned at four edges of the bottom plate, the bottom plate defines a through hole communicating with the male mold chamber.

11. The male mold of claim 10, wherein the male mold comprises a pressing plate protruding into the male mold chamber through the through hole.

12. The male mold of claim 10, wherein the male mold base comprises four position blocks positioned at corners of the frame, each molding block and the respective driving block are received between two adjacent position blocks.

13. The male mold of claim 8, wherein one end of each bolt penetrates the respective driving block and is rotatably connected to the respective molding block.

14. The male mold of claim 8, wherein the driving devices drives the driving blocks to move.
